(19) United States
(12) Patent Application Publication
(10) Pub. No.: US 2015/0162788 A1
(43) Pub. Date: Jun. 11, 2015

(54) ROTOR CORE ASSEMBLY FOR A RELUCTANCE MOTOR AND MANUFACTURING METHOD OF THE SAME

(71) Applicant: METAL INDUSTRIES RESEARCH & DEVELOPMENT CENTRE, Kaohsiung City (TW)

(72) Inventors: Hsing-Chih TSAI, Kaohsiung City (TW); Hsin-Te WANG, Kaohsiung City (TW); Shou-Chang HWANG, Kaohsiung City (TW); Guang-Miao HUANG, Kaohsiung City (TW); Rong-Bin LIN, Kaohsiung City (TW); Ming-Hung CHIEN, Kaohsiung City (TW); Chih-Yuan YANG, Kaohsiung City (TW)

(73) Assignee: METAL INDUSTRIES RESEARCH & DEVELOPMENT CENTRE

(21) Appl. No.: 14/557,988

(22) Filed: Dec. 2, 2014

(30) Foreign Application Priority Data
Dec. 9, 2013 (TW) 102145233

(51) Int. Cl. H02K 1/24; B23K 31/02; H02K 15/02; B23K 1/00

(52) U.S. Cl. CPC H02K 1/246; B23K 1/0016; B23K 31/02; H02K 15/022

(57) ABSTRACT

A rotor core assembly for a reluctance motor and a manufacturing method of the same, wherein the rotor core assembly has multiple silicon steel laminations and a nonmagnetic material. The silicon steel laminations are axially stacked, and each silicon steel lamination has multiple magnetic flux sections. Each magnetic flux section has multiple arcuate grooves and multiple salient poles. The arcuate grooves are concentrically arranged. The salient poles protrude into the grooves. The nonmagnetic material is disposed in the grooves, and is wrapped around the salient poles, which enables the silicon steel laminations to remain securely assembled together. The salient poles are disposed in the grooves to avoid ruining the magnetic line of force. As a result, the rotor core assembly can keep rigidity of the assembled silicon steel laminations, and can keep the integrity of the magnetic circuit.

### CROSS-REFERENCE TO RELATED APPLICATIONS

This application is based upon and claims priority under 35 U.S.C. 119 from Taiwan Patent Application No. 102145233 filed on Dec. 9, 2013, which is hereby specifically incorporated herein by this reference thereto.

### BACKGROUND OF THE INVENTION

1. Field of the Invention

The present invention relates to a rotor core assembly and a manufacturing method of the same, especially to a rotor core assembly for a reluctance motor and a manufacturing method of the same.

2. Description of the Prior Arts

A reluctance motor is a widely available electric motor that comprises a rotor rotated by a magnetic field generated by a stator field core. With reference to FIG. 11, U.S. Pat. No. 5,929,551 discloses a conventional rotor core assembly 40 to make the rotor form a desired magnetic circuit. The conventional rotor core assembly 40 comprises multiple arcuate silicon steel laminations 41 that are radially stacked to form multiple sets. Arcuate magnetic lines 42 of force of each arcuate silicon steel lamination 41 correspond to the magnetic field generated by the stator. The arcuate silicon steel laminations 41 are radially and annularly arranged around a shaft 43 to form multiple magnetic flux sections. Multiple star-shaped mounting laminations 44 are mounted around the shaft 43, and each star-shaped mounting lamination 44 has a mounting pin 45. The mounting pin 45 is formed radially on the mounting lamination 44, and is mounted through the silicon steel laminations 41. An end of the mounting pin 45 is riveted on the silicon steel lamination 41. However, the assembling is complicated and the aligning is hardly accurate when the radially stacked silicon steel laminations 41 are being assembled. In addition, the mounting pins 45, which are mounted through the silicon steel laminations 41, may ruin the magnetic lines 42 of force formed by the arcuate silicon steel laminations 41, and cause the loss of the magnetic circuit.

With reference to FIG. 12, U.S. Pat. No. 7,489,062 discloses another conventional rotor core assembly that comprises silicon steel laminations mounted in recesses 51 of a mounting bracket 50. Therefore, the assembling problems are solved, and structures of the silicon steel laminations are not damaged. However, the adding of the mounting bracket 50 causes additional manufacturing process and increases the cost.

As a result, an improved rotor core assembly is provided as disclosed in U.S. Pat. No. 6,815,859, which comprises multiple circular silicon steel laminations axially stacked to form the core assembly to solve the assembling problem and the high-cost problem mentioned above. However, the axially stacked silicon steel laminations are assembled together via annular ribs formed around peripheries of the silicon steel laminations, and the annular ribs are so large that the annular ribs may shorten part of the magnetic circuit, which causes the loss of the magnetic circuit.

To overcome the shortcomings, the present invention provides a rotor core assembly and a manufacturing method of the same to mitigate or obviate the aforementioned problems.

### SUMMARY OF THE INVENTION

The main objective of the present invention is to provide a rotor core assembly for a reluctance motor and a manufacturing method of the same that is easy for assembly and can avoid loss of the magnetic circuit.

The rotor core assembly comprises multiple silicon steel laminations and a nonmagnetic material. The silicon steel laminations are axially stacked, and each silicon steel lamination has a shaft hole and multiple magnetic flux sections. The shaft hole is formed through a center of the silicon steel lamination. The magnetic flux sections are disposed adjacent to an outer edge of the silicon steel lamination, are arranged apart from each other, and each magnetic flux section has multiple arcuate grooves and multiple salient poles. The arcuate grooves are concentrically arranged, and each arcuate groove has an opening disposed toward the outer edge of the silicon steel lamination. The salient poles protrude into the grooves. The nonmagnetic material is disposed in the grooves and is wrapped around the salient poles.

The manufacturing method of the rotor core assembly mentioned above comprises steps of: stamping multiple silicon steel laminations, wherein each silicon steel lamination has a central shaft hole, multiple magnetic flux sections, and an outer annular rib; each magnetic flux section has multiple arcuate grooves and multiple salient poles; the arcuate grooves are concentrically arranged, and each arcuate groove has an opening disposed toward an outer edge of the silicon steel lamination; the salient poles protrude into the grooves; the outer annular rib is formed around the outer edge of the silicon steel lamination and surrounds the magnetic flux sections; axially stacking the silicon steel laminations, wherein the silicon steel laminations are aligned concentrically with the central shaft hole, and then are axially stacked; filling in a nonmagnetic material, wherein the nonmagnetic material is filled into the grooves of the silicon steel laminations and is wrapped around the salient poles; cutting off the outer annular ribs, wherein the outer annular ribs of the silicon steel laminations are processed to be cut off

Stacking the silicon steel laminations can simplify the manufacturing and the assembling. Wrapping the nonmagnetic material around the salient poles enables the silicon steel laminations to remain securely assembled together after the outer annular ribs of the silicon steel laminations are cut off, thereby keeping rigidity of the assembled silicon steel laminations. The salient poles are disposed in the grooves to avoid causing the loss of the magnetic line of force, which can keep the integrity of the magnetic circuit, and thus enhances the output performance of the motor.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a rotor core assembly in accordance with the present invention;

FIG. 2 is a perspective view of a second embodiment of a rotor core assembly in accordance with the present invention;

FIG. 3 is a flow chart of a manufacturing method in accordance with the present invention;

FIG. 4 is a top view of the rotor core assembly in FIG. 1, showing stamped silicon steel laminations;

FIG. 5 is a perspective view of the rotor core assembly in FIG. 1, showing the stacked silicon steel laminations;

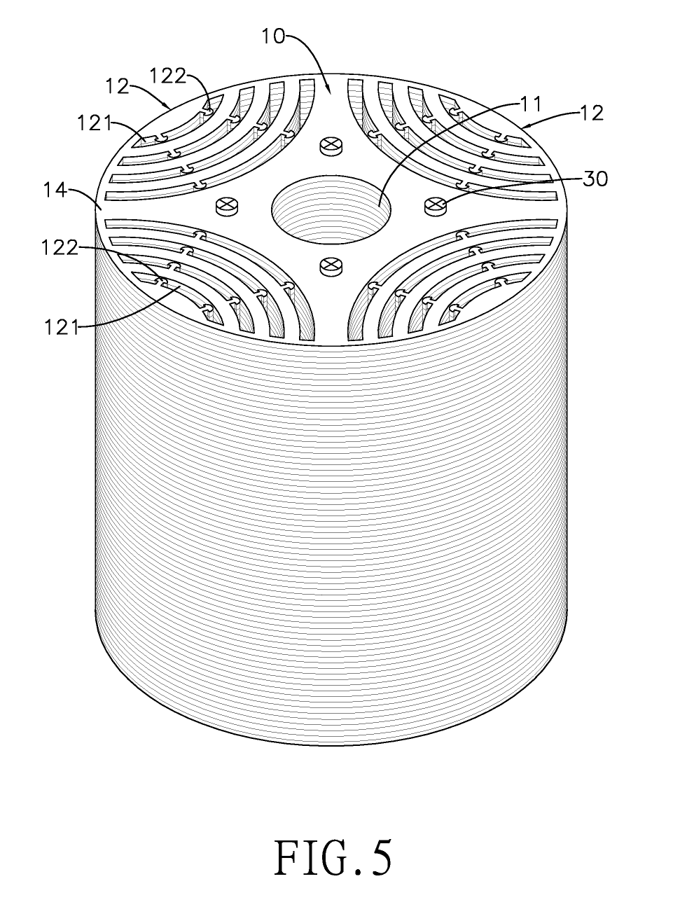

FIG. 6 is a side view in partial section of the rotor core assembly in FIG. 1, showing screws mounted through the silicon steel laminations;

FIG. 7 is a side view in partial section of the rotor core assembly in FIG. 1, showing the soldered silicon steel laminations;

FIG. 8 is a side view in partial section of the rotor core assembly in FIG. 1, showing the silicon steel laminations engaged in engaging recesses;

FIG. 9 is a top view of the rotor core assembly in FIG. 1, showing the silicon steel laminations filled with nonmagnetic material;

FIG. 10 is a top view of the rotor core assembly in FIG. 1, showing outer annular ribs of the silicon steel laminations are cut off;

FIG. 11 is an end view of a conventional rotor core assembly in accordance with the prior art; and

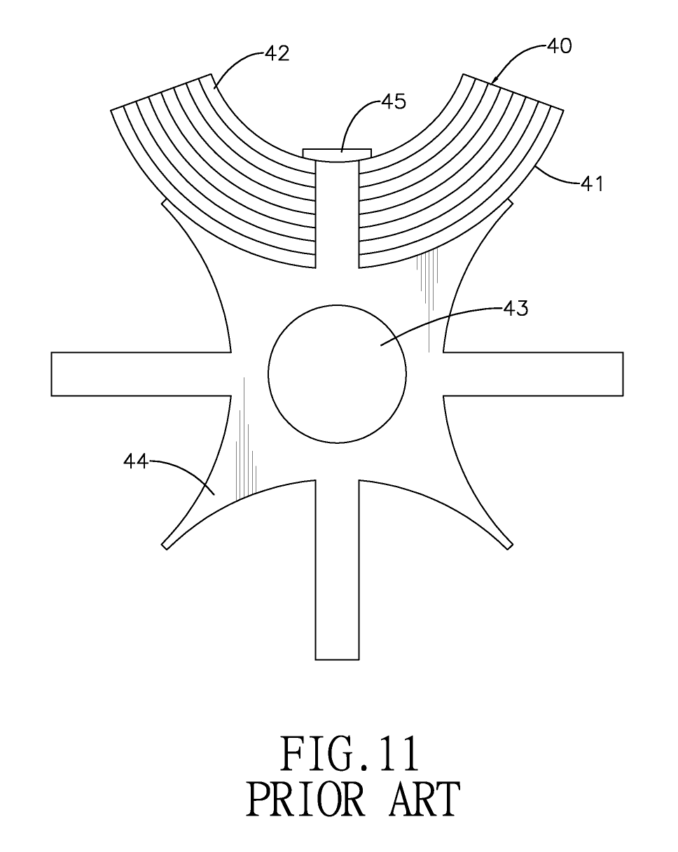

FIG. 12 is a perspective view of a mounting bracket of another conventional rotor core assembly in accordance with the prior art.

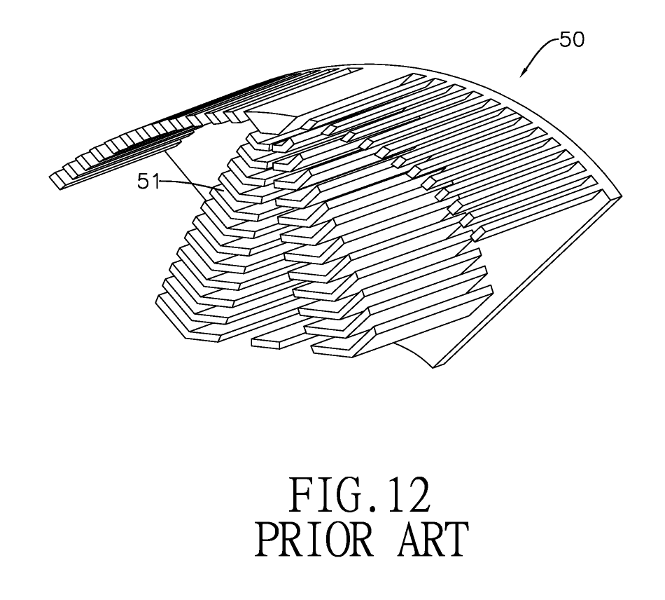

### DETAILED DESCRIPTION OF THE PREFERRED EMBODIMENTS

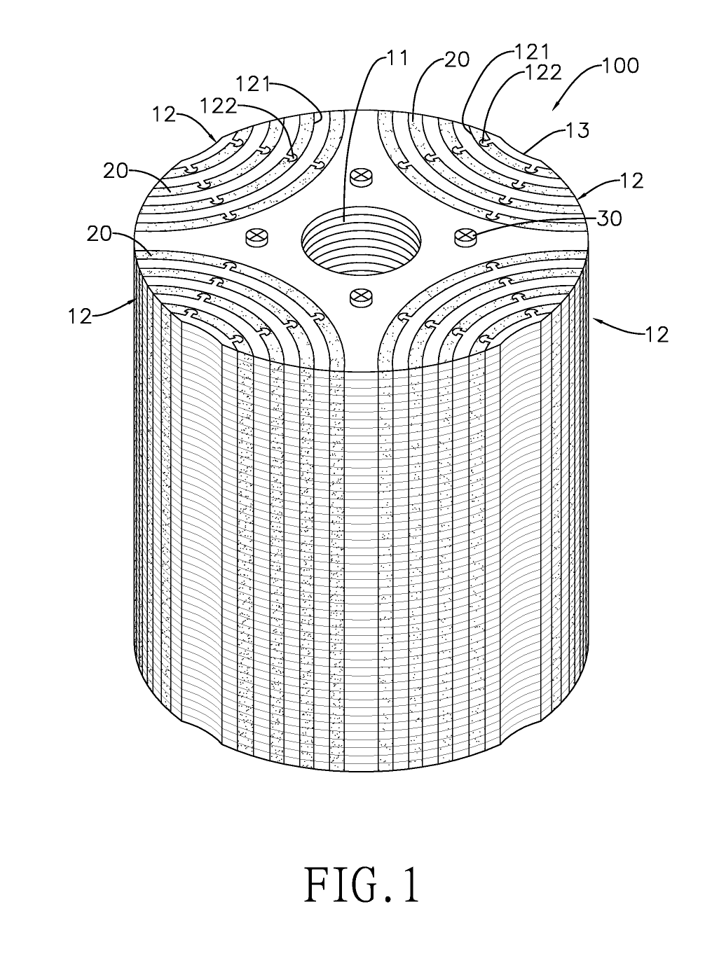

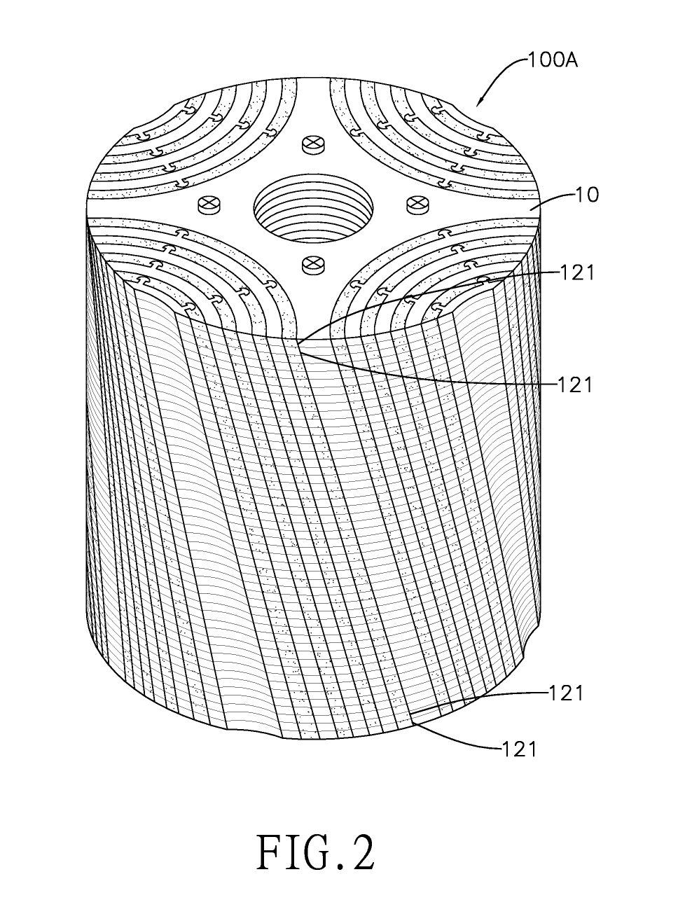

With reference to FIGS. 1 and 2, a rotor core assembly 100 for a reluctance motor in accordance with the present invention comprises multiple silicon steel laminations 10 and a nonmagnetic material 20. The silicon steel laminations 10 are axially stacked, and each silicon steel lamination 10 has a shaft hole 11 and multiple magnetic flux sections 12. The shaft hole 11 is formed through a center of the silicon steel lamination 10. The magnetic flux sections 12 are disposed adjacent to an outer edge of the silicon steel lamination 10 and are arranged apart from each other. Each magnetic flux section 12 has multiple arcuate grooves 121, multiple salient poles 122 and an edge recess 13. The arcuate grooves 121 are concentrically arranged, and each arcuate groove 121 has an opening disposed toward the outer edge of the silicon steel lamination 10. The salient poles 122 protrude into the grooves 121. The edge recess 13 is formed in the outer edge of the silicon steel lamination 10, and corresponds in position to the opening of the outermost arcuate groove 121. The nonmagnetic material 20 is filled into the grooves 121, and is wrapped around the salient poles 122 to securely fix the stacked silicon steel laminations 10. In a preferred embodiment, to meet different requirements, the corresponding grooves 121 of each of the silicon steel laminations 10 of the rotor core assembly 100 are linearly aligned, such that the corresponding magnetic flux sections 12 are linearly aligned as shown in FIG. 1. Or the corresponding grooves 121 of each of the silicon steel laminations 10 are obliquely aligned, such that the corresponding magnetic flux sections 12 are obliquely aligned as shown in FIG. 2.

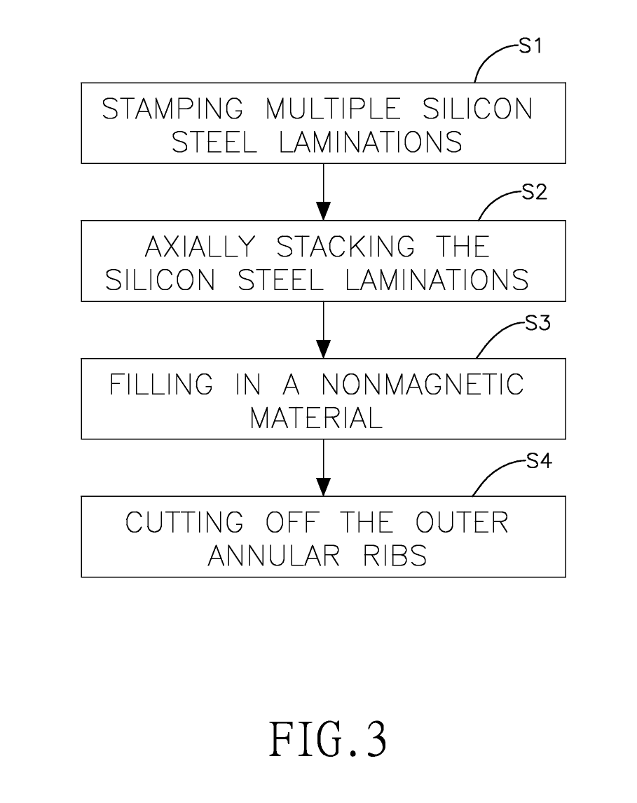

With reference to FIG. 3, a manufacturing method of the rotor core assembly 100 for a reluctance motor in accordance with the present invention comprises the following steps.

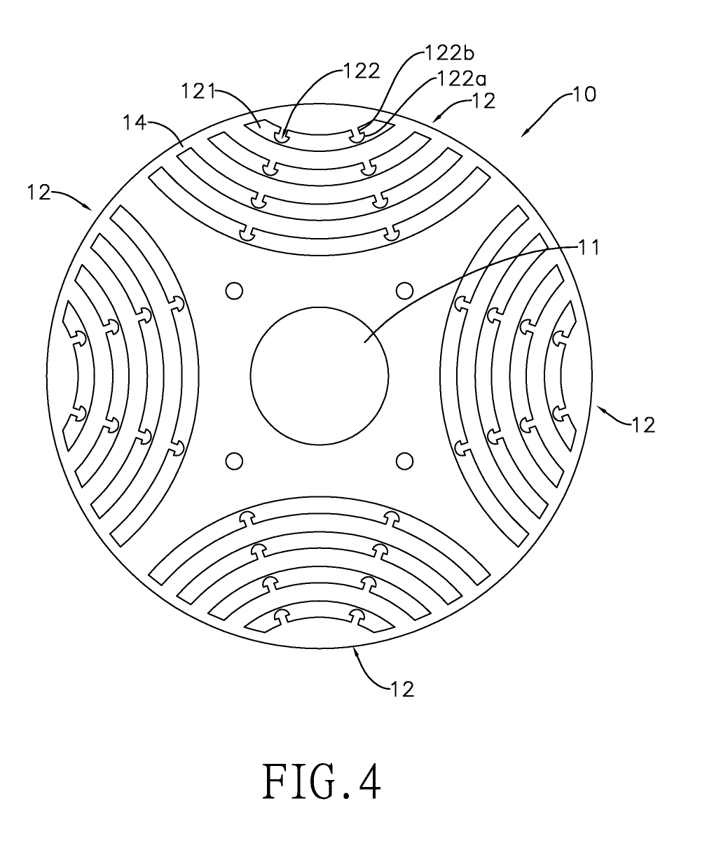

Stamping multiple silicon steel laminations (S1): With reference to FIGS. 3 and 4, the silicon steel laminations 10 are stamped. Each silicon steel lamination 10 has a central shaft hole 11, multiple magnetic flux sections 12, and an outer annular rib 14. Each magnetic flux section 12 has multiple arcuate grooves 121 and multiple salient poles 122. The arcuate grooves 121 are concentrically arranged, and each arcuate groove 121 has an opening disposed toward an outer edge of the silicon steel lamination 10. The salient poles 122 protrude into the grooves 121. The outer annular rib 14 is formed around the outer edge of the silicon steel lamination 10, and surrounds the magnetic flux sections 12. In a preferred embodiment, each salient pole 122 has a head part 122a and a neck part 122b. The neck part 122b is connected to the head part 122a, and is smaller than the head part 122a in width, thereby increasing a contact area to engage with solder afterwards, and strengthening the engagement to the solder. Preferably, each salient pole 122 is mushroom-shaped from a top view.

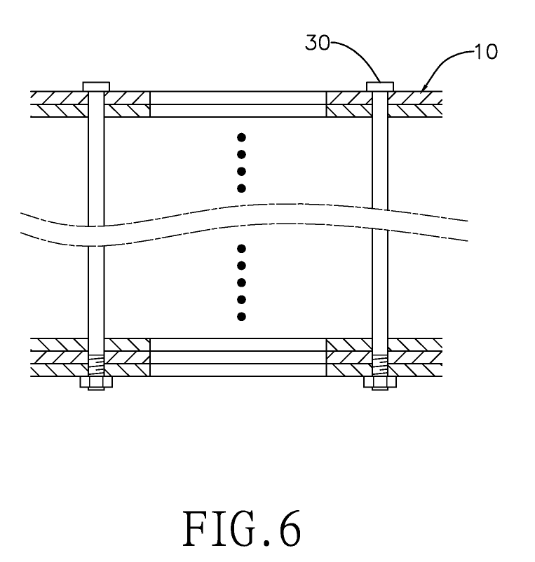

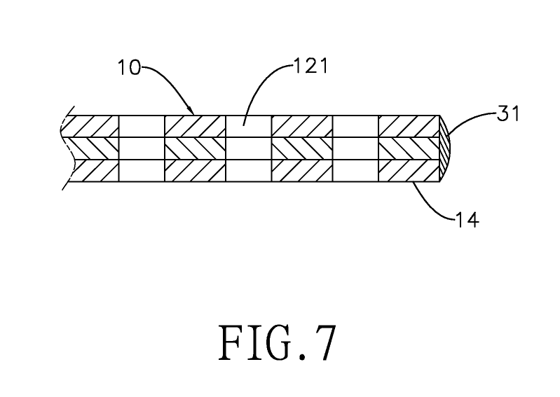

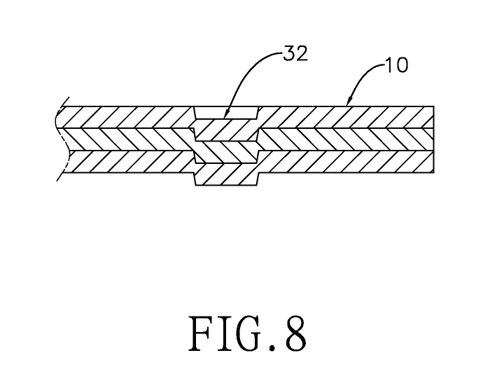

Axially stacking the silicon steel laminations (S2): With reference to FIGS. 3 and 4, the silicon steel laminations 10 are aligned concentrically with the central shaft hole 11, and then are axially stacked. In a preferred embodiment, the silicon steel laminations 10 are held in position relative to each other by a supplementary fixing means before being axially stacked. For example, the supplementary fixing means may be using at least one screw 30 axially and securely mounted in the silicon steel laminations 10 as shown in FIG. 6, securely soldering the silicon steel laminations 10 via solders 31 on the outer annular ribs 14 as shown in FIG. 7, or forming at least one engaging recess 32 on a surface of each silicon steel lamination 10, and then engaging the engaging recesses 32 of any two adjacent silicon steel laminations 10 with each other as shown in FIG. 8.

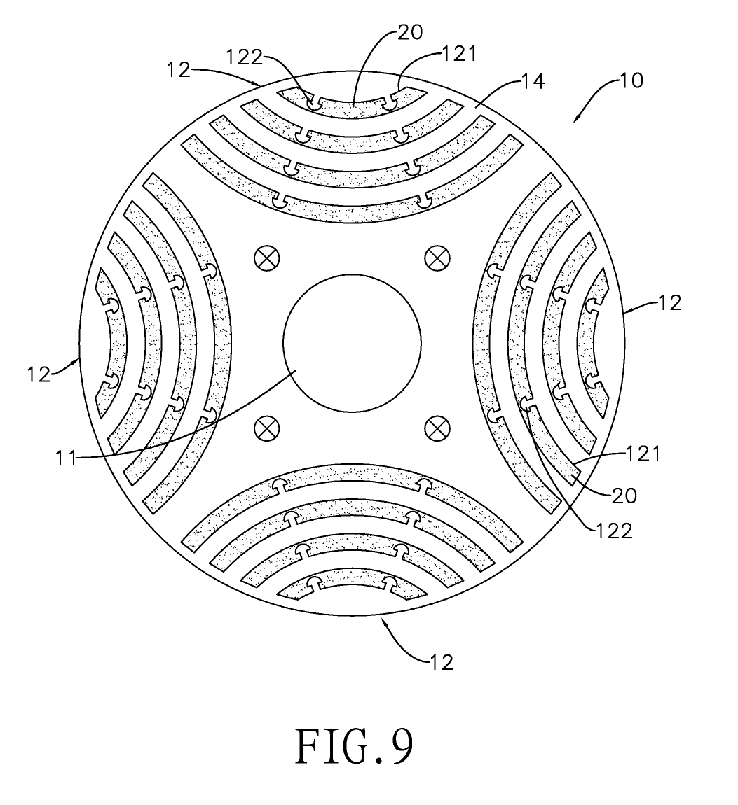

Filling in a nonmagnetic material (S3): With reference to FIGS. 3 and 9, the nonmagnetic material 20 is filled into the grooves 12 of the silicon steel laminations 10, and is wrapped around the salient poles 122 to securely fix the stacked silicon steel laminations 10 via the nonmagnetic material 20. In a preferred embodiment, the nonmagnetic material 20 is not only filled into the grooves 12 of the silicon steel laminations 10, but also wrapped around the two silicon steel laminations 10 that are at two axial ends of the overall stacked silicon steel laminations 10 to form a protective layer.

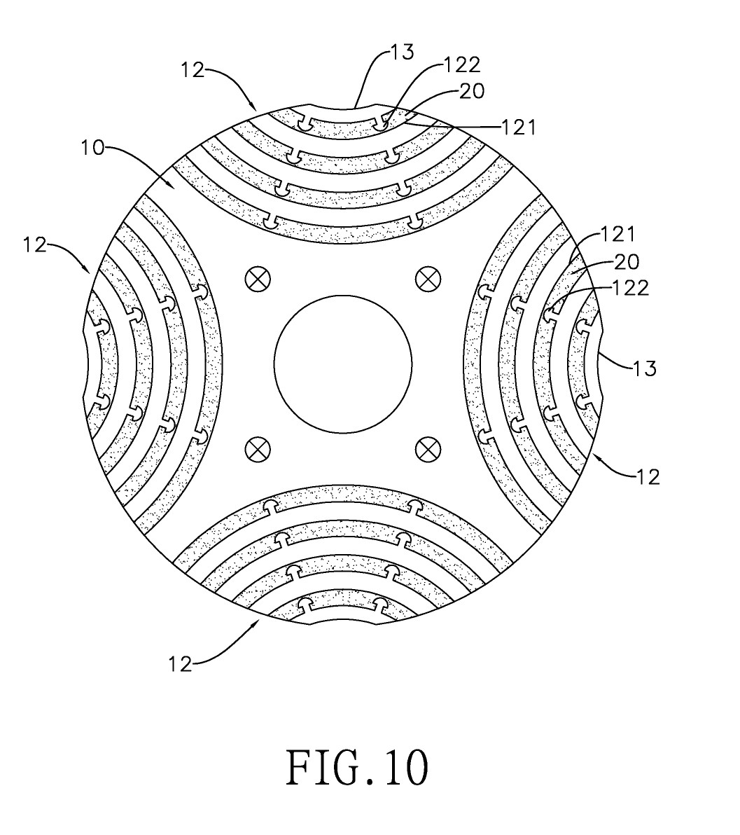

Cutting off the outer annular ribs (S4): With reference to FIGS. 3, 10 and 1, the outer annular ribs 14 of the silicon steel laminations 10 are processed to be cut off to get the rotor core assembly 100. In a preferred embodiment, the protective layer mentioned above can protect the two silicon steel laminations 10 that are at two axial ends of the overall stacked silicon steel laminations 10 when in process of cutting off the outer annular ribs 14. When the outer annular ribs 14 of said two silicon steel laminations 10 are cutting off, a thickness of the protective layer achieves the support effect to prevent said two silicon steel laminations 10 from being peeled off since the workpiece is too thin. In a preferred embodiment, multiple edge recesses 13 are formed in the outer edge of each silicon steel lamination 10 when the outer annular ribs 14 are cut off Each edge recess 13 corresponds in position to the opening of the outermost arcuate groove 121.

When the rotor core assembly 100 is in use, a shaft of a rotor is mounted through the central shaft hole 11, and then the rotor core assembly 100 and the shaft are mounted in the motor stator. When the motor is actuated, arcuate magnetic lines of force are generated in the arcuate grooves 121 of the silicon steel laminations 10 to interact with a rotating magnetic field generated by the stator, thereby simultaneously rotating the rotor.

Tightly wrapping the nonmagnetic material 20 around the salient poles 122 enables the stacked silicon steel laminations 10 to be securely assembled together, which further prevents the core assembly 100 from being separated when the rotor rotates. The salient poles 122 are disposed in the grooves 121, such that the magnetic line of force is not damaged. As a result, the present invention can keep the bonding strength as well as maintain the integrity of the magnetic circuit.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rotor core assembly for a reluctance motor, the rotor core assembly comprising:
multiple silicon steel laminations axially stacked, and each silicon steel lamination having
a shaft hole formed through a center of the silicon steel lamination; and
multiple magnetic flux sections disposed adjacent to an outer edge of the silicon steel lamination, arranged apart from each other, and each magnetic flux section having
multiple arcuate grooves concentrically arranged, and each arcuate groove having an opening disposed toward the outer edge of the silicon steel lamination; and
multiple salient poles protruding into the grooves; and
a nonmagnetic material disposed in the grooves and wrapped around the salient poles.

2. The rotor core assembly as claimed in claim 1, wherein the corresponding grooves of each of the silicon steel laminations are linearly aligned, such that the corresponding magnetic flux sections are linearly aligned.

3. The rotor core assembly as claimed in claim 1, wherein the corresponding grooves of each of the silicon steel laminations are obliquely aligned, such that the corresponding magnetic flux sections are obliquely aligned.

4. The rotor core assembly as claimed in claim 1, wherein each magnetic flux section has
an edge recess formed in the outer edge of the silicon steel lamination, and corresponding in position to the opening of the outermost arcuate groove.

5. The rotor core assembly as claimed in claim 1, wherein each salient pole has
a head part; and
a neck part connected to the head part and being smaller than the head part in width.

6. The rotor core assembly as claimed in claim 5, wherein each salient pole is mushroom-shaped from a top view.

7. A manufacturing method of the rotor core assembly as claimed in claim 1, the manufacturing method comprising steps of:
stamping multiple silicon steel laminations, wherein each silicon steel lamination has a central shaft hole, multiple magnetic flux sections, and an outer annular rib; each magnetic flux section has multiple arcuate grooves and multiple salient poles; the arcuate grooves are concentrically arranged, and each arcuate groove has an opening disposed toward an outer edge of the silicon steel lamination; the salient poles protrude into the grooves; the outer annular rib is formed around the outer edge of the silicon steel lamination and surrounds the magnetic flux sections;
axially stacking the silicon steel laminations, wherein the silicon steel laminations are aligned concentrically with the central shaft hole, and then are axially stacked;
filling in a nonmagnetic material, wherein the nonmagnetic material is filled into the grooves of the silicon steel laminations and is wrapped around the salient poles; and
cutting off the outer annular ribs, wherein the outer annular ribs of the silicon steel laminations are processed to be cut off

8. The manufacturing method as claimed in claim 7, wherein in the step of axially stacking the silicon steel laminations, the silicon steel laminations are held in position relative to each other by a supplementary fixing means before being axially stacked.

9. The manufacturing method as claimed in claim 8, wherein in the step of axially stacking the silicon steel laminations, the supplementary fixing means is using at least one screw axially and securely mounted in the silicon steel laminations.

10. The manufacturing method as claimed in claim 8, wherein in the step of axially stacking the silicon steel laminations, the supplementary fixing means is securely soldering the silicon steel laminations via solders on the outer annular ribs.

11. The manufacturing method as claimed in claim 8, wherein in the step of axially stacking the silicon steel laminations, the supplementary fixing means is forming at least one engaging recess on a surface of each silicon steel lamination, and then engaging the engaging recesses of any two adjacent silicon steel laminations with each other.

12. The manufacturing method as claimed in claim 7, wherein in the step of cutting off the outer annular ribs, multiple edge recesses are formed in the outer edge of each silicon steel lamination, and each edge recess corresponds in position to the opening of the outermost arcuate groove.

13. The manufacturing method as claimed in claim 7, wherein in the step of filling in the nonmagnetic material, the nonmagnetic material is wrapped around the two silicon steel laminations that are at two axial ends of the overall stacked silicon steel laminations.
